(19) United States
(12) Patent Application Publication
(10) Pub. No.: US 2009/0198819 A1
(43) Pub. Date: Aug. 6, 2009

(54) Method and System for Providing the Internet Service with Advertisement

(75) Inventors: Wen-Yi Kuo, Taipei City (TW); Yi-Hao Chang, Yong-Ho City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BANDRICH INC., Sindian City (TW)

(21) Appl. No.: 12/023,261

(22) Filed: Jan. 31, 2008

(51) Int. Cl. G06F 15/16

(52) U.S. Cl. 709/228

(57) ABSTRACT

A method for providing an Internet service with advertisement is provided. First, a computing device installs an ad-playing application and runs the ad-playing application to request a telecommunication network for a connection to the Internet. Then, the telecommunication network establishes the connection for it and transfers advertisement to the computing device. Then, the ad-playing application plays the advertisement on the screen of the computing device. Last, the telecommunication network disconnects the connection when the advertisement is not played on the computing device. Moreover, A system for providing the Internet service with advertisement is disclosed in the specification.

### BACKGROUND

1. Field of Invention

The present invention relates to an advertising method and system. More particularly, the present invention relates to an advertising method and system wherein advertisement is provided together with an Internet service.

2. Description of Related Art

With the fast development of the Internet, people who access the Internet are steadily increasing. A wide variety of electronic commerce is conducted in this way. Many companies are improving business by unleashing the full potential of the Internet.

In general, conventional advertisements may appear on web pages. For example, the advertisement may be displayed on the web page when the user views the web page. Alternatively, advertisements are linked to the web pages of the respective advertiser. By clicking on the link, the user views the advertiser's web page. However, the advertisements that appear on web pages seem to make little impression on the users.

On the other hand, the user uses the Internet service provided by the telecommunications service provider in order to let the user's equipment access the Internet. However, the telecommunications service provider charges some amount of fees for the Internet service.

For the foregoing reasons, there is a need for a method and a system for providing the Internet service with advertisement such that the fees of the Internet service may be reduced and the effect of the advertising improved.

### SUMMARY

It is therefore an objective of the present invention to provide a method for providing the Internet service with advertisement.

In accordance with an embodiment of the present invention, the method for providing the Internet service with advertisement comprises the following steps. First, the connection is established between the computing device and the Internet. Then, the advertisement is transferred to the computing device. Then, whether the computing device plays the advertisement is determined. Finally, the connection is disconnected when the advertisement is not played on the computing device.

It is another objective of the present invention to provide a system for providing the Internet service with advertisement.

In accordance with another embodiment of the system for providing the Internet service with advertisement comprises a computing device, a telecommunication network and an advertisement server. The computing device installs an ad-playing application. The telecommunication network establishes a connection to the Internet for the computing device. The advertisement server transfers advertisements to the computing device, the computing device plays the advertisement by means of the ad-playing application, the telecommunication network determines whether the ad-playing application plays the advertisement, and then the telecommunication network disconnects the connection when the ad-playing application doesn't play the advertisement.

It is to be understood that both the foregoing general description and the following detailed description are by examples, and are intended to provide further explanation of the invention as claimed.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1-5 is a schematic diagram of a system for providing the Internet service with advertisement according to an embodiment of the present invention;

FIG. 6 is a flow chart of a method for providing the Internet service with advertisement according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

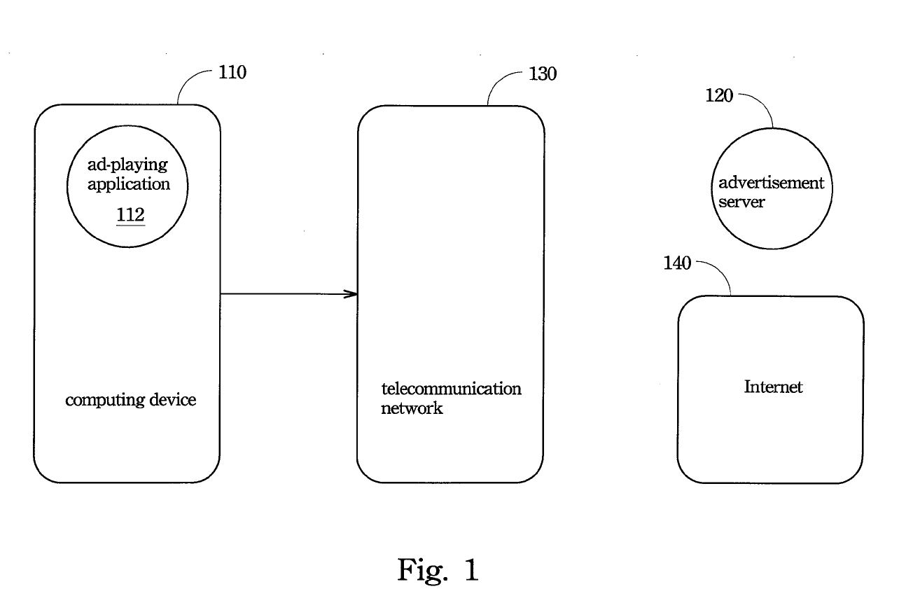

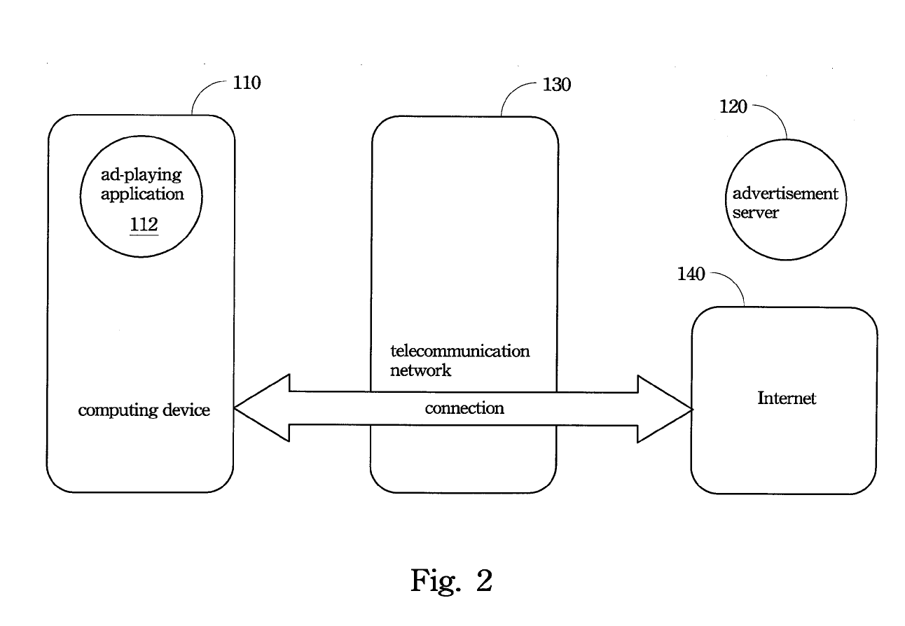

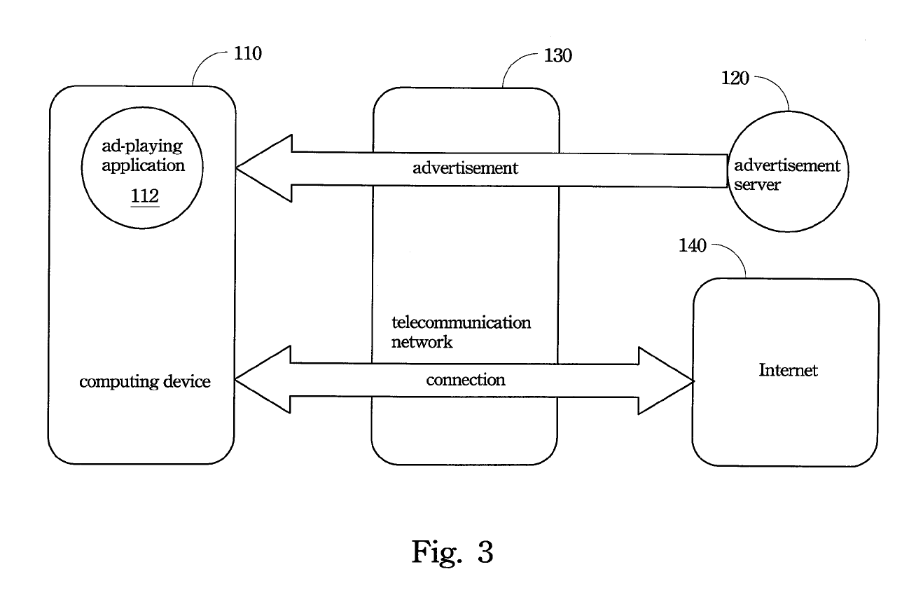

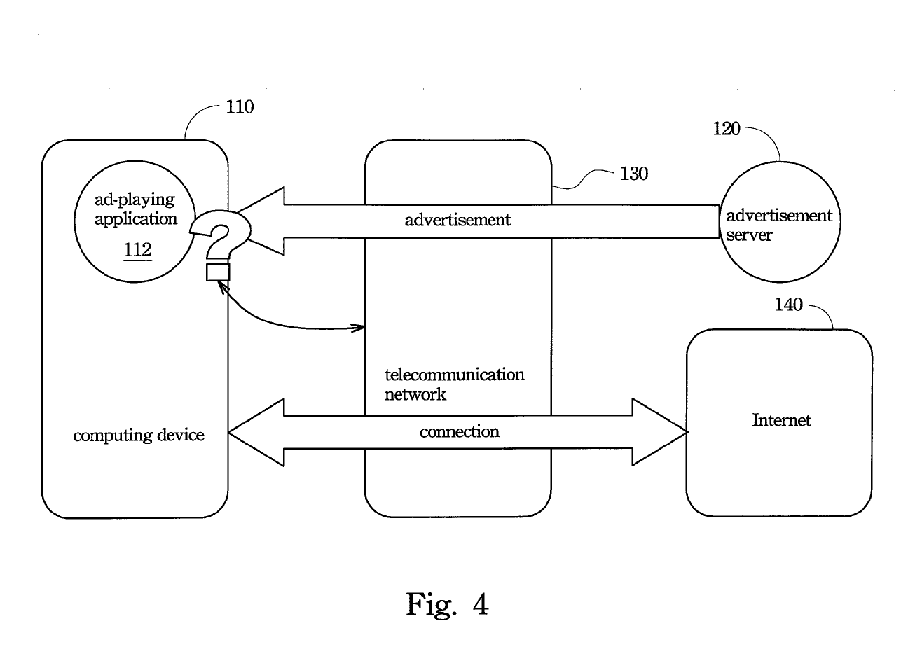

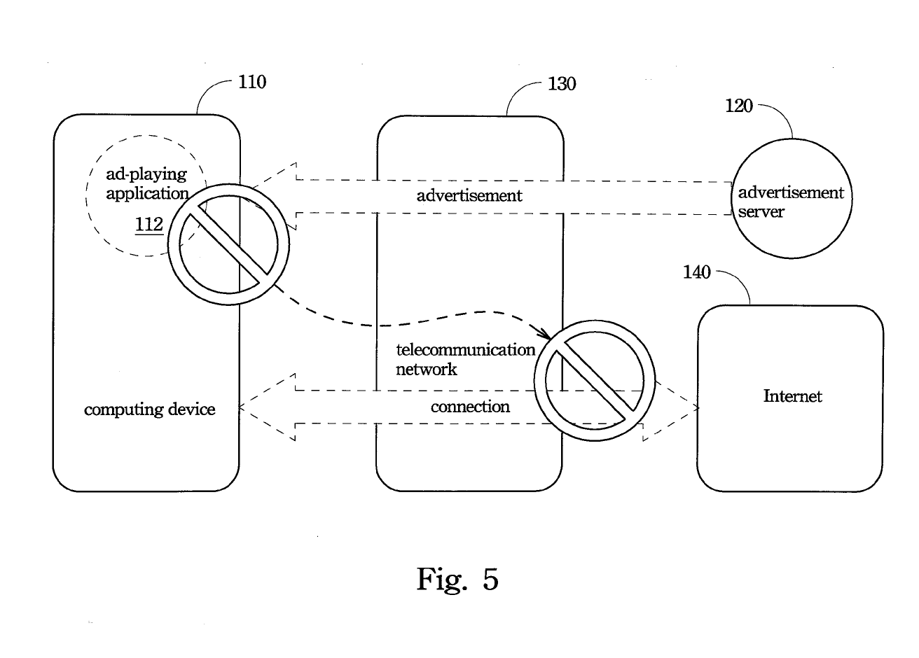

Please refer to FIG. 1, FIG. 2, FIG. 3, FIG. 4 and FIG. 5 simultaneously. FIG. 1, FIG. 2, FIG. 3, FIG. 4 and FIG. 5 are schematic diagrams of a system for providing the Internet service with advertisement according to an embodiment of the present invention. The system may comprise a computing device 110, an advertisement server 120 and a telecommunication network 130.

Please refer to FIG. 1. If the user wants to access the Internet 140, he or she may use the computing device 110 in which an ad-playing application 112 is installed, where the computing device 110 may be a computer, a PDA, a cell phone or the like. Then, the computing device 110 runs the ad-playing application 112 to request a connection to the Internet 140, where the connection between the computing device 110 and the Internet 140 may be through the telecommunication network 130 that is provided by the telecommunications service provider. For example, the telecommunication network 130 may be a mobile network, such as WiFi, WiMax, 3G, 3.5G, 3G LTE (Long Term Evolution) or the like.

Please refer to FIG. 2. When a request is received from the computing device 110, the telecommunication network 130 may establish the connection between the computing device 110 and the Internet 140. Therefore, the user may access the Internet 140. For example, the user may access Web Page or send E-mail, etc.

Please refer to FIG. 3. After the connection between the computing device 110 and the Internet 140 is established, the advertisement server 120 transfers at least one advertisement to the computing device 110. Then, the computing device 110 receives the advertisement and plays the advertisement by means of the ad-playing application 112. Thus, the user should watch and/or listen to the advertisement provided by advertisers, but the advertisers may pay the fees to the telecommunications service provider for the connection. It should be noted that the advertisement may be a video, a picture, an audio file, a text advert or a combination thereof. For example, the computing device 110 may play the advertisement that is a combination of video, audio and subtitles. Alternatively, the advertisement may be similar to filmstrips displaying continuous commercial pictures. In an embodiment, the computing device 110 may comprise a screen (not shown). The different advertisements are respectively displayed on different portions of the screen of the computing device 110. Furthermore, the computing device 110 may intermittently or continuously play the advertisement by means of the ad-playing application 112. One of ordinary skill in the art will appreciate that the above examples are provided for illustrative purposes only to further explain applications of the present invention and are not meant to limit the present invention in any manner.

Please refer to FIG. 4. In an embodiment, the telecommunication network 130 determines whether the computing device 110 plays the advertisement. More specifically, the telecommunication network 130 may send a checking signal to the computing device 110. If the computing device 110 plays the advertisement and receives the checking signal, the computing device 110 responds to the checking signal and sends a responding signal to the telecommunication network 130. Then, the telecommunication network 130 determines that the computing device 110 plays the advertisement according to the responding signal. For example, the telecommunication network 130 may be a mobile network, and the computing device 110 may include a SIM card (not shown), where the SIM card issued by an operator of the telecommunication network may generate the responding signal according to the checking signal. On the other hand, if the computing device 110 doesn't play the advertisement, the computing device 110 doesn't respond to the checking signal. Then, during a predetermined period, the telecommunication network 130 doesn't receive the responding signal, such that the telecommunication network 130 detects that the computing device 110 isn't playing the advertisement. In other embodiments, if the computing device 110 plays the advertisement, the computing device 110 may periodically send a reporting signal to the telecommunication network 130. Then, the telecommunication network 130 receives the reporting signal sent from the computing device 110 during a predetermined period and determines that the computing device 110 plays the advertisement. On the contrary, if the computing device 110 doesn't play the advertisement, the computing device 110 may not send a reporting signal. Then, during a predetermined period, the telecommunication network 130 doesn't receive the reporting signal sent from the computing device 110, such that the telecommunication network 130 determines that the computing device 110 isn't playing the advertisement. It will be readily understood by those skilled in the art that the above-mentioned predetermined period may be varied while remaining within the scope of the present invention. For example, the predetermined period may be 1 minute, or the like.

Please refer to FIG. 5. If the telecommunication network 130 detects that the computing device 110 doesn't play the advertisement, the telecommunication network 130 disconnects the connection between the computing device 110 and the Internet 140. On the contrary, if the computing device 110 plays the advertisement, the telecommunication network 130 maintains the connection between the computing device 110 and the Internet 140. Then, the telecommunication network 130 may proceed to determine whether the computing device 110 is playing the advertisement.

Moreover, after the connection between the computing device 110 and the Internet 140 is established, i.e. the computing device 110 may access the Internet 140, the telecommunication network 130 may count the period during the connection; alternatively, the telecommunication network 130 may count the amount of the packets during the connection. Therefore, according to the period or the amount of the packets, the advertisers may pay some fees to the telecommunications service provider. For example, the telecommunications service provider may charge for 0.00625 dollars a minute for the connection; alternatively, the telecommunications service provider may charge for 0.000016 dollars a packet for the connection. Thus, the user may use the computing device 110 to access the Internet 140 without paying any fees, but he or she would have to watch and/or listen to the advertisement. On the other hand, the advertisers may pay some fees for the connection between the computing device 110 and the Internet 140. It should be appreciated that not only the user may access the Internet without any fee, but also the advertisers may target their advertisement to their preferred demographic.

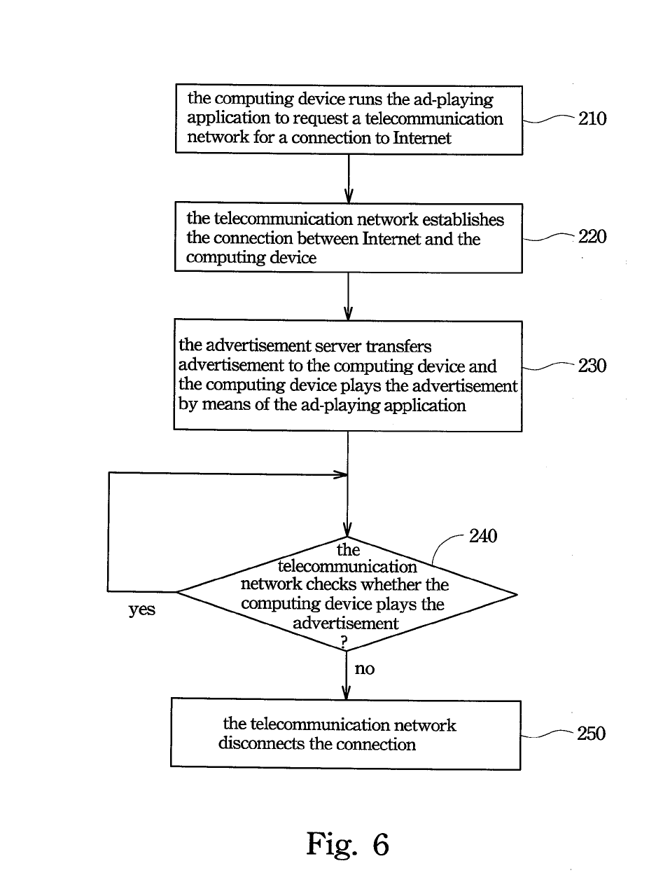

Please refer to FIG. 6. FIG. 6 is a flow chart of a method for providing the Internet service with advertisement according to an embodiment of the present invention. First, in step 210, the computing device 110 runs the ad-playing application 112 to request the telecommunication network 130 for the connection to the Internet 140, where the computing device 110 may be a computer, a PDA, a cell phone, or the like. Then, in step 220, the telecommunication network 130 establishes the connection between the computing device 110 and the Internet 140. Then, in step 230, the advertisement server 120 transfers an advertisement to the computing device 110. The ad-playing application 112 plays the advertisement on the computing device 110, where the advertisement may be a video, a picture, an audio file, a text advert or a combination thereof. Additionally, the computing device 110 may comprise a screen (not shown). The different advertisements are respectively displayed on different portions of the screen of the computing device 110. Furthermore, the computing device 110 may intermittently or continuously play the advertisement by means of the ad-playing application 112. Then, in step 240, the telecommunication network 130 determines whether the computing device 110 plays the advertisement. If the computing device 110 doesn't play the advertisement, the telecommunication network 130 disconnects the connection between the computing device 110 and the Internet 140 in step 250. On the other hand, if the computing device 110 plays the advertisement, the telecommunication network 130 maintains the connection. Then, the step 240 may be repeated in an iterative manner, i.e. the telecommunication network 130 proceeds to determine again whether the computing device 110 plays the advertisement.

Moreover, the above-mentioned step 240 may include the following sub-steps. First, the telecommunication network 130 sends a checking signal to the computing device 110. Then, if the computing device 110 plays the advertisement and receives the checking signal, the computing device 110 responds to the checking signal and sends a responding signal to the telecommunication network 130. For example, the telecommunication network 130 may be a mobile network, and the computing device 110 may include a SIM card (not shown), where the SIM card issued by an operator of the telecommunication network may generate the responding signal according to the checking signal. Then, the telecommunication network 130 receives the responding signal during a predetermined period. Therefore, the telecommunication network 130 maintains the connection between the computing device 110 and the Internet 140. Additionally, the telecommunication network 130 proceeds to sends a checking signal to the computing device 110. On the other hand, if the computing device 110 doesn't play the advertisement, the computing device 110 doesn't respond to the checking signal. Then, the telecommunication network 130 doesn't receive the responding signal. Therefore, the telecommunication network 130 disconnects the connection between the computing device 110 and the Internet 140. Alternatively, the above-mentioned step 240 may include the following sub-steps. First, if the computing device 110 plays the advertisement, the computing device 110 may periodically send a reporting signal to the telecommunication network 130. Then, during a predetermined period, the telecommunication network 130 receives the reporting signal sent from the computing device 110. Therefore, the telecommunication network 130 maintains the connection between the computing device 110 and the Internet 140. Additionally, the telecommunication network 130 may receive the reporting signal at regular intervals. On the contrary, if the computing device 110 doesn't play the advertisement, the computing device 110 may not send a reporting signal. Then, the telecommunication network 130 doesn't receive the reporting signal. Therefore, the telecommunication network 130 disconnects the connection between the computing device 110 and the Internet 140.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for providing the Internet service with advertisement, comprising:
installing an ad-playing application in a computing device;
establishing a connection between the computing device and the Internet, wherein the connection is through a telecommunication network;
transferring advertisement to the computing device;
determining whether the computing device plays the advertisement; and
disconnecting the connection when the advertisement is not played on the computing device.

2. The method as claimed in claim 1, further comprising:
maintaining the connection when the advertisement is played on the computing device and proceeding to determine whether the computing device plays the advertisement.

3. The method as claimed in claim 1, wherein the step of establishing the connection between the computing device and the Internet comprising:
running the ad-playing application to request for the connection.

4. The method as claimed in claim 1, wherein the computing device plays the advertisement by means of the ad-playing application, wherein the ad-playing application intermittently or continuously plays the advertisement, and the different advertisements are respectively displayed on different portions of a screen of the computing device.

5. The method as claimed in claim 1, wherein the advertisement is a video, a picture, an audio file, a text advert or a combination thereof.

6. The method as claimed in claim 1, wherein the computing device is a computer, a PDA or a cell phone.

7. The method as claimed in claim 1, wherein the step of determining whether the computing device plays the advertisement comprising:
sending a checking signal to the computing device; and
sending a responding signal from the computing device in response to the checking signal when the advertisement is played.

8. The method as claimed in claim 7, wherein the responding signal sent from the computing device is generated according to the checking signal by a SIM card in the computing device.

9. The method as claimed in claim 7, wherein the computing device doesn't send the responding signal when the advertisement is not played.

10. The method as claimed in claim 1, wherein the step of determining whether the computing device plays the advertisement comprising:
receiving a reporting signal from the computing device; and
determining the computing device doesn't play the advertisement when the reporting signal is not received during a predetermined period.

11. A system for providing the Internet service with advertisement, comprising:
a computing device, wherein the computing device is installed an ad-playing application;
a telecommunication network for establishing a connection between the computing device and the Internet; and
an advertisement server, wherein the advertisement server transfers advertisement to the computing device, the computing device plays the advertisement by means of the ad-playing application, the telecommunication network determines whether the ad-playing application plays the advertisement, and the telecommunication network disconnects the connection when the ad-playing application doesn't play the advertisement.

12. The system as claimed in claim 11, wherein the telecommunication network maintains the connection and proceeds to determine whether the computing device plays the advertisement when the advertisement is played on the computing device.

13. The system as claimed in claim 11, wherein the computing device runs the ad-playing application to request for the connection.

14. The system as claimed in claim 11, wherein the computing device is a computing device, a PDA or a cell phone.

15. The system as claimed in claim 11, wherein the advertisement is a video, a picture, an audio file, a text advert or a combination thereof.

16. The system as claimed in claim 11, wherein the computing device comprising:
a screen for displaying the advertisement, wherein the ad-playing application intermittently or continuously plays the different advertisements on different portions of the screen, respectively.

17. The system as claimed in claim 11, wherein the telecommunication network sends a checking signal to the computing device, and the computing device sends a responding signal in response to the checking signal when the computing device plays the advertisement.

18. The system as claimed in claim 17, wherein the computing device comprising:
a SIM card for generating the responding signal according to the checking signal.

19. The system as claimed in claim 17, wherein the computing device doesn't send the responding signal when the advertisement is not played.

20. The system as claimed in claim 11, wherein the computing device sends a reporting signal to the telecommunication network, and the telecommunication network disconnects the connection when the reporting signal is not received during a predetermined period.
